(19) United States
(12) Patent Application Publication
(10) Pub. No.: US 2021/0145168 A1
(43) Pub. Date: May 20, 2021

(54) MULTI-PURPOSE STAND FOR COMPUTING DEVICES

(71) Applicant: Joel Heath, Santa Barbara, CA (US)

(72) Inventor: Joel Heath, Santa Barbara, CA (US)

(21) Appl. No.: 17/160,647

(22) Filed: Jan. 28, 2021

(51) Int. Cl. A47B 23/04; B43L 1/00; F16M 11/22; F16M 11/10

(52) U.S. Cl. CPC A47B 23/043; B43L 1/00; A47B 2023/049; F16M 11/10; F16M 11/22

(57) ABSTRACT

A multi-purpose stand for computing devices is provided. The multi-purpose stand includes a first surface adapted for placement of a computing device, wherein the computing device is placed on the first surface and retained using one or more supporting means. The multi-purpose stand further includes a second surface having a front side and a back side, wherein the first surface is extended to form the second surface and wherein the front side of the second surface is used for writing and/or drawing by a user. The multi-purpose stand further includes a third surface, wherein the third surface is connected to the back side of the second surface and for supporting for the second surface.

### FIELD OF THE INVENTION

The present invention relates generally to a stand for placing a computing device and, more particularly, to a multi-purpose stand for placing a computing device and for writing/drawing by a user.

### BACKGROUND

Computing devices have been around for many years now. Various computing devices such as a laptop, a computer is used by users around the world for making their lives easier. As the use of computing devices increase, users desire a comfortable way for using the computing device. One such comforting way of using a computing device, for example a laptop, is a use of a laptop stand. Laptop stands allow a user to place the laptop at a level of the eyes of the user. This allows for better ergonomics for user while allowing the user to use the laptop for more time.

There may be scenarios where the user may want to write/draw some content while also using the computing device. This may be while attending to an office meeting, attending to college class where the user while attending to meeting/class desires to jot down some important points. In that scenario the user may have to search for a paper and a pen. However, sometimes in hassle the user may not be able to find the pen and the paper and may miss jotting down the points. Also, using a paper may not be environmentally friendly.

With the above disadvantages in mind, there arises a need for the user which may conveniently allow a user to jot down points while using the computing device without the hassle of finding a paper.

### BRIEF SUMMARY

In one non-limiting embodiment, a multi-purpose stand for computing devices is provided. The multi-purpose stand comprises a first surface, having one or more supporting means, for placing a computing device, wherein the computing device is placed on the first surface using one or more supporting means. The multi-purpose stand further comprises a second surface having a front side and a back side, wherein the first surface is extended to form the second surface and wherein the front side of the second surface is used for writing and/or drawing by a user.

The multi-purpose stand further comprises a third surface, wherein the third surface is connected to the back side of the second surface and for supporting the second surface.

These and other features and advantages of the invention will become apparent from the detailed description below, in light of the accompanying drawings.

### BRIEF DESCRIPTION OF THE ACCOMPANYING DRAWINGS

These, as well as other features of the present invention, will become more apparent upon reference to the drawings wherein:

FIG. 1 shows a multi-purpose stand for placing a computing device in accordance with one embodiment of the present disclosure.

FIG. 2 shows a process for manufacturing the multi-purpose stand in accordance with one embodiment of the present disclosure.

FIGS. 3a-3f shows different views of the multi-purpose stand in accordance with one embodiment of the present disclosure.

FIG. 4 shows a multi-purpose stand with a felt pad on a first surface in accordance with one embodiment of the present disclosure.

FIGS. 5a-5g shows different shapes of the felt pads in accordance with one embodiment of the present disclosure.

FIG. 6 depicts an exemplary embodiment of the multi-purpose stand with a laptop placed on the first surface in accordance with one embodiment of the present disclosure.

FIGS. 7a-7b depicts an exemplary embodiment of the multi-purpose stand in accordance with one embodiment of the present disclosure.

### DETAILED DESCRIPTION

As used in the specification and claims, the singular forms “a”, “an” and “the” include plural references unless the context clearly dictates otherwise. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. References to “one embodiment”, “an embodiment”, “another embodiment”, “an example”, “one implementation”, “some embodiment”, and so on, indicate that the embodiment(s) or example(s) so described may include a particular feature, structure, characteristic, property, element, or limitation, but that not every embodiment or example necessarily includes that particular feature, structure, characteristic, property, element or limitation. Further, unless stated otherwise, terms such as “first”, “second”, are used to arbitrarily distinguish between the elements such terms describe. Thus, these terms are not necessarily intended to indicate temporal or other prioritization of such elements.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Present disclosure provides a multi-purpose stand for placing a computing device and for writing/drawing by a user.

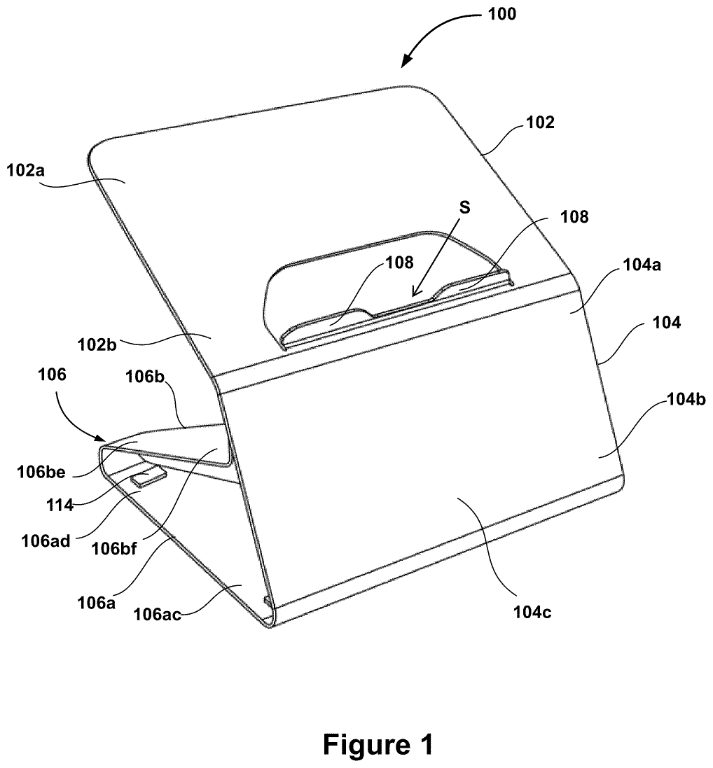

FIG. 1 shows a multi-purpose stand 100 in accordance with one embodiment of the present disclosure. The multi-purpose stand 100 as shown in FIG. 1 comprises of a first surface 102, a second surface 104 and a third surface 106. Details of the first surface 102, the second surface 104 and the third surface 106 are described below.

The first surface 102 is a surface used for placing a computing device. For example, the first surface 102 may be used to place a laptop. The first surface 102 is made of a metal. For example, the first surface 102 may be made of steel or aluminum material. However, the materials mentioned here are not restricted to the one mentioned here and may include any material.

The first surface 102 may have an upper end 102a and a lower end 102b. The arrangement of the first surface 102 is such that the upper end 102a forms a slope with respect to the lower end 102b. In other words, the upper end 102a is at a higher level than the lower end 102b. This slope ensures that the computing device is placed at a level of the eyes of the user. This arrangement ensures that there is no stress to the eyes of the user while the user is using the computing device.

The shape and size of the first surface 102 is such that the computing device completely fits the first surface 102. In one embodiment, the shape of the first surface 102 is rectangular and the size is similar to the size of a laptop. However, the shape and the size may not be restricted to the one mentioned here and the first surface 102 may have any shape and size.

To place the computing device on the first surface 102 such that it does not fall or downwardly slide from the first surface 102, one or more supporting means 108 are provided. The one or more supporting means 108 may be placed at the lower end 102b. The one or more supporting means 108 may include protrusions placed at the lower end 102b such that the computing device is supported or retained in place by these protrusions while being placed on the first surface 102.

In one embodiment, the two protrusions may be separated by a pre-defined distance forming a region there between (represented by letter ‘S’) such that a user can easily open the computing device by placing his/her fingers along the region. In another embodiment, the pre-defined distance may not be provided, and a single protrusion may extend from one end of the lower end 102b to the other end of the lower end 102b.

The first surface 102 extends to form a second surface 104. In particular, the first surface 102 may extend from the side of the lower end 102b to form the second surface 104. For example, the first surface 102 may extend from the lower end 102b such that second surface 104 of the size and shape of the first surface 102 may be formed. Thus, the second surface 104 may be an extension of the first surface 102. However, in one embodiment, the size and shape of the second surface 104 may be different from the size and shape of the first surface 102.

In detail, the second surface 104 may also include an upper end 104a and a lower end 104b. The upper end 104a of the second surface 104 may be connected to the lower end 102b of the first surface 102. In other words, the lower end 102b of the first surface 102 may be curved to extend and form an upper end 104a of the second surface 104. In one embodiment, due to curve arrangement, an angle may be formed between the upper end 104a of the second surface 104 and the lower end 102b of the first surface 102. In one embodiment, the angle may be 30 degrees. However, the angle is not limited to the one mentioned here and may be any angle.

In one embodiment, the upper end 104a is arranged such that the upper end 104a is inclined at a predefined angle with respect to the lower end 104b. In other words, the second surface 104 is in a slanting shape similar to the first surface 102.

The second surface 104 is also be formed of metal. For example, the second surface 104 may be formed of aluminum or steel. However, the material is not limited to the one mentioned here and may include any material.

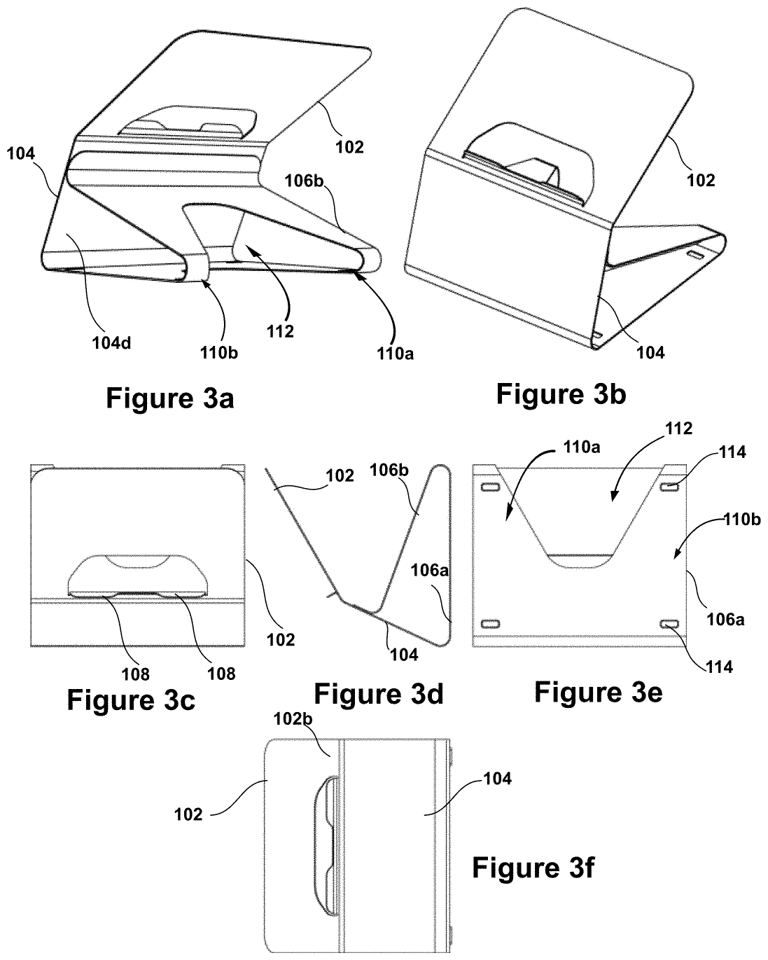

The second surface 104 includes a front side 104c and a back side 104d (shown in FIG. 3a). The front side 104c of the second surface 104 has a powder coating. The powder coating on the front side 104c may be white board powder coating. The white board powder coating makes it possible for a user to write/draw on the front side 104c while using the computing device placed on the first surface 102.

The white board powder coating makes the front side 104c similar to a white board known in the art. Thus, the writing/drawings may be done by a white board marker known in the art. Further, the white board powder coatings may make it easy for the user to erase the content written/drawn by the user on the second surface 104.

In one embodiment, a user may desire to write/draw on some other means instead of writing on the second surface 104. In one embodiment, the other means may include a paper. In such case, since the second surface 104 is made of steel material, one or more magnets may be affixed on the second surface 104 so as to hold the other means (for example a paper) in place while the user writes/draws on the paper. In other word, the magnets may act as paper weights to prevent the paper from falling from the second surface.

In another embodiment, the magnets may be affixed on any of the first surface 102, the second surface 104 and the third surface 106 since the first surface 102, the second surface 104 and the third surface 106 are all made of steel (as described above)

In one embodiment, the white board powder coatings may be applied to the whole of the multi-purpose stand 100. In other words, the white board powder coatings may be applied to the first surface 102, the second surface 104 and the third surface 106. This makes the first surface 102, the second surface 104 and the third surface 106 work as a white board and the user may write/draw using a white board marker on the first surface 102, the second surface 104 and the third surface 106.

Referring to FIG. 1 again, the second surface 104 further extends from the lower end 104b to form a third surface 106. The third surface 106 is such that the third surface 106 forms a base for the multi-purpose stand 100. As shown in FIG. 1, the second surface 104 may be curved at the lower end 104b such that the second surface 104 extends and forms a third surface 106 (via 106ac as explained below).

The third surface may be divided into two parts—a base surface 106a and a slant surface 106b. The base surface 106a may be curved and extended to form the slant surface 106b. In other words, the base surface 106a may have a first end 106ac directly connected with the lower end 104b of the second surface 104. The base surface 106a may form a base for the multi-purpose stand 100 and may be connected to the slant surface 106b. In other words, the base surface 106a forms a base on which the multi-purpose stand 100 rests. The base surface 106a may have a rectangular shape. However, the shape may not be restricted to the one mentioned here and may have any other shape.

The base surface 106a may further have a second end 106ad. The second end 106ad of the base surface 106a may be curved and may extend so as to form the slant surface 106b. In particular, the slant surface 106b may have a first end 106be directly connected to the second end 106ad of the base surface 106 and a second end 106bf (of the slant surface 106b) directly connected to the back side 104d of the second surface 104. The connection to the back side 104d may be by means of one or more welding means. In other words, the second end 106bf of the slant surface 106b may be welded with the back side 104d of the second surface 104.

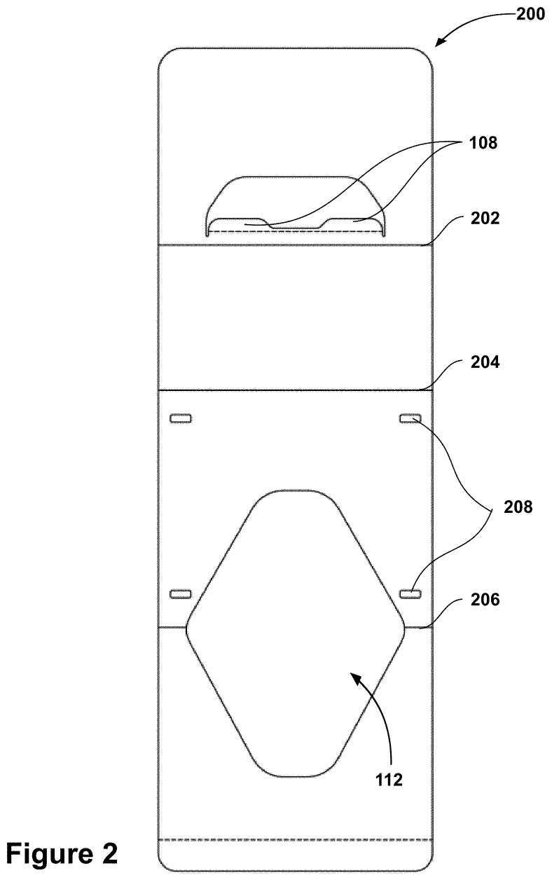

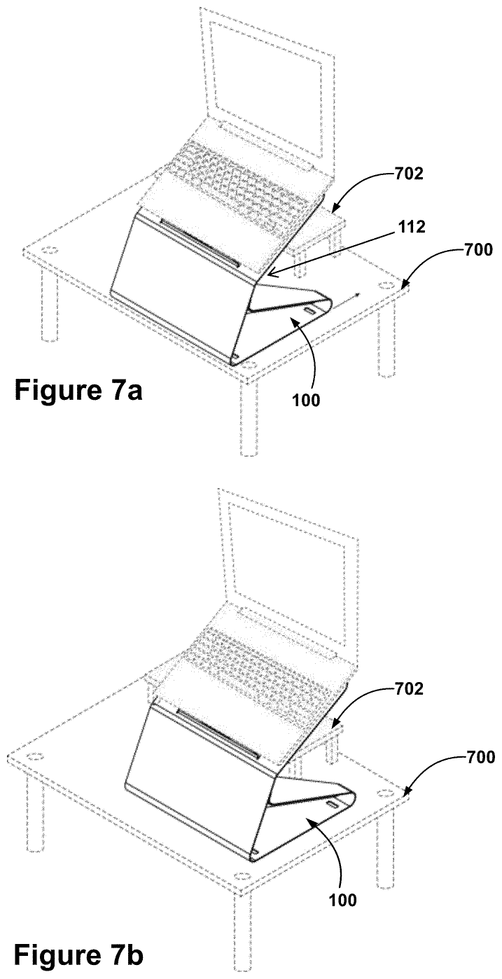

The slant surface 106b of the third surface 106 may be divided into two halves—a first half 110a and a second half 110b (as shown in FIG. 3e). The first half 110a and the second half 110b may be separated by a gap 112 in between. This gap 112 between the first half 110a and the second half 110b is explained below in FIG. 2 and its advantage can be understood with respect to FIGS. 7a-7b.

The multipurpose stand 100 of the present invention may further include one or more cushioning means 114 provided on the third surface 106. More particularly, the one or more cushioning means 114 may be provided at the corners of the base surface 106a of the third surface 106. The one or more cushioning means 114 may be used to provide cushioned surface for the multi-purpose stand 100 when the multi-purpose stand 100 is placed on any surface. In one embodiment, the one or more cushioning means 114 may include rubber pads, silicon pads.

Referring to FIG. 2, a brief process of manufacturing the multi-purpose stand 100 of FIG. 1 is explained. As shown in FIG. 2, a working piece of metal sheet 200 is shown. Typically, a flat sheet of metal is cut on a laser, water jet or die cut first to get the working piece of metal 200. The metal sheet 200 is folded or bent at ends 202, 204, 206 as shown in FIG. 2 to form the first surface 102, the second surface 104 and the third surface 106 described above in FIG. 1. For example, the metal sheet 200 may be folded at the end 202 to form a first surface 102, folded at 204 to form second surface 104. Further, the metal sheet 200 may be folded at 206 such that portion above 206 is forms as base surface 106a and the portion below 206 forms the slant surface 106b. Further, FIG. 2 shows apertures or slots 208 that may receive the cushioning means 114 discussed above. The cutout section shown in FIG. 2 depicts the gap 112 between the first half 110a and second 110b (as explained above). The cutout section may be formed in various shapes such as diamond shape, square shape, circular shape, oval shape and so on.

The process as explained in FIG. 2 may be performed by one or more machines available at a manufacturing facility. For example, there may be one or more machines which may automate the manufacturing process of multi-purpose stand 100. For example, the working sheet of metal 200 may be bent at ends 202, 204, 206 using a variety of press brakes to achieve necessary bending.

Referring to FIGS. 3a-3f now, different views of the multi-purpose stand 100 are shown. FIG. 3a depicts a rear perspective view of the multi-purpose stand 100. As shown in FIG. 3a, a back side of the first surface 102, the second surface 104 and slant surface 106b of the third surface 106 and the gap 112 between the two halves 110a and 110b are shown.

FIG. 3b shows a front perspective view of the multi-purpose stand 100. FIG. 3b shows the extension of the first surface 102 to form the second surface 104.

FIG. 3c depicts the top view of the multi-purpose stand 100. The top view shows the first surface 102 with supporting means 108 and the pre-defined distance between the supporting means 108.

FIG. 3d shows a side view showing of the first surface 102 extended to form the second surface 104. FIG. 3d also shows the third surface 106 having a base surface 106a and the slant surface 106b.

FIG. 3e shows a bottom view of the multi-purpose stand 100. FIG. 3e shows base surface 106a with two halves (110a and 110b) separated by a gap 112. Further, FIG. 3e shows cushioning means 114 at four corners of the base surface 106a.

FIG. 3f shows a connection of the first surface 102 with the second surface 104. As shown in this figure, the first surface 102 is extended towards the lower end 102b so as to form the second surface 104.

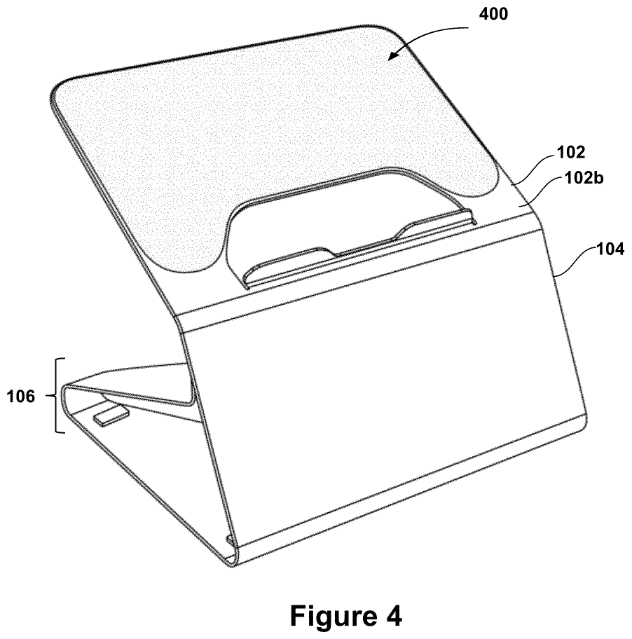

In one embodiment, the multi-purpose stand 100 may include one or more felt pads 400 (explained in FIG. 4 below) on the first surface 102. The felt pads 400 on the first surface 102 helps provide cushioning to the computing device placed on the first surface 102. This may also be done so as to prevent scratches on the first surface 102 of the stand 100.

FIG. 4 shows a felt pad 400 placed on the first surface 102. Referring to FIG. 4 along with FIG. 1, the felt pad 400 shown in FIG. 4 starts from the upper end 102a of the first surface 102 and extends towards the lower end 102b of the first surface 102 of the stand 100. In other words, the felt pad 400 shown in FIG. 4 is made rectangular in shape such that the computing device when rested or positioned on the first surface 102 fully covers the felt pad 400 The felt pads may be constructed of wool or felt material. The felt pad can also be formed of a deformable resilient material to stabilize the object to give a support surface. The felt pad may be secured to the first surface by mechanical bonding or adhesive bonding.

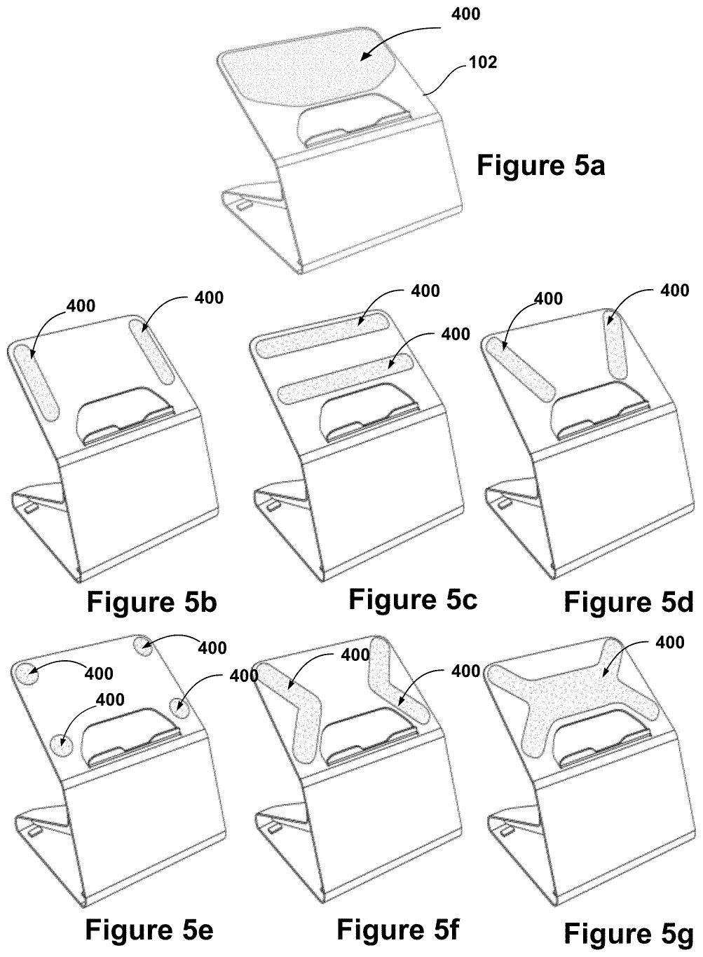

In one embodiment, the one or more felt pads 400 may have different shapes. FIGS. 5a-5g depicts different shapes of the felt pads 400 configured on the multipurpose stand.

Referring to FIG. 5a, one or more felt pads 400 on the first surface 102 are shown. The one or more felt pads 400 are placed in a rectangular format as per FIG. 5a. In other words, the one or more felt pads 400 are placed such that the shape of the one or more felt pads is similar to the one of the computing devices. This ensures that the one or more felt pads 400 completely cover back of the computing device.

Referring to FIG. 5b, the one or more felt pads 400 are placed vertically in a form of strips. As shown in FIG. 5b, the one or more felt pads 400 are placed at the two ends of the first surface 102. This ensures that the ends of the computing device are protected, and the computing device is properly placed on the first surface 102.

Referring to FIG. 5c, the one or more felt pads 400 are placed horizontally in a form of strips. As shown in FIG. 5c, the one or more felt pads 400 are placed at one end of the first surface 102 and above the protrusions. This arrangement provides cushioning to computing device in the middle and also ensures that the computing device is properly placed on the first surface 102.

Referring to FIG. 5d, the one or more felt pads 400 are placed diagonally in a form of strips. As shown in FIG. 5d, the one or more felt pads 400 are placed at two ends of the first surface 102. This arrangement provides cushioning to computing device in the middle and also ensures that the computing device is properly placed on the first surface 102.

Referring to FIG. 5e, the one or more felt pads 400 are placed at four corners of the first surface 102. This ensures that cushioning for the corners of the computing device.

Referring to FIG. 5f, the one or more felt pads 400 are placed in the form of strips covering the ends of the first surface 102. This arrangement ensures cushioning for the computing device at the ends.

Referring to FIG. 5g, the one or more felt pads 400 are provided at the ends and in the middle of the first surface 102. As shown in FIG. 5g, the one or more felt pads 400 extends from the ends and extends towards the center of the first surface 102. This ensures cushioning for the computing device in the middle and at the ends.

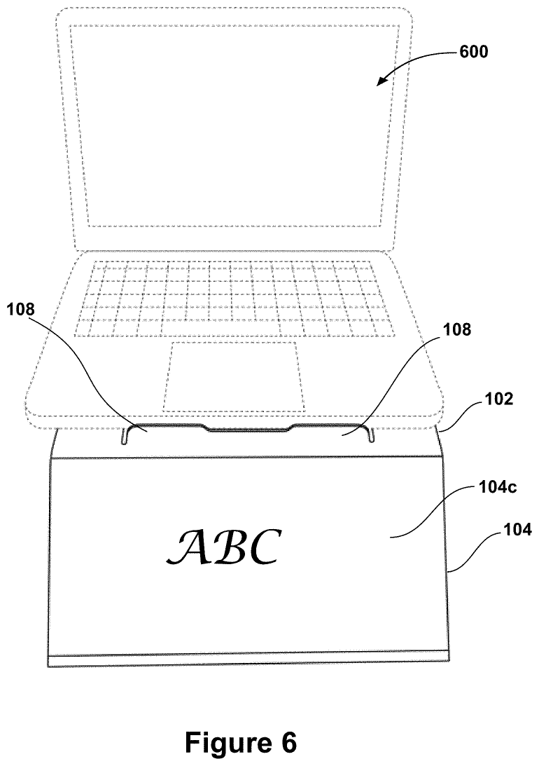

Referring now FIG. 6, an exemplary embodiment showing the multi-purpose stand 100 with a computing device 600 placed on the first surface 102. As shown in FIG. 6, the computing device 600 is a laptop.

FIG. 6 shows laptop placed on the first surface 102 at an inclination. As explained earlier, the inclination ensures that the laptop is placed at the height of the eyes of the user such that there is no strain/stress to the user while using the laptop. Further, FIG. 6 shows the second surface 104 coated with white board powder coatings. This coating ensures that the user can write/draw on the second surface 104. The coating also ensures that the content written/drawn by the user is easily erasable. As shown in FIG. 6, the user has written “ABC” on the second surface 104 (specifically on the front side 104c of the second surface 104). The user may use a white board marker to write the content on the second surface 104. Also, as shown in FIG. 6, the laptop 600 is supported by protrusions (i.e elements 108) on the first surface 102. The protrusions ensure that the laptop does not fall and is properly retained on the first surface 102.

Referring to FIGS. 7a and 7b now, an exemplary embodiment of the multi-purpose stand 100 showing advantages of having a gap 112 between the first half 110a and the second half 110b on the third surface 106 is depicted. As shown in FIGS. 7a and 7b, the multi-purpose stand 100 is placed on a four legged-platform 700. Also, another four-legged platform 702 is shown which is placed behind the multi-purpose stand 100.

As shown in FIG. 7a in conjunction with FIG. 3e, the arrow illustrates that the multi-purpose stand 100 is slidable and the gap 112 between the first half 110a and the second half 110b ensures that the four-legged platform 702 behind the multi-purpose stand 100 can be placed inside the gap 112. This prevents the multi-purpose stand 100 and the four-legged platform 702 from taking additional space.

FIG. 7b shows the final placement of the multi-purpose stand 100. As shown in FIG. 7b, the gap 112 between the first half 110a and the second half 110b fully covers the four-legged platform 702 ensuring that there is no extra space taken or minimal space is taken by the multi-purpose stand 100. Additionally, the gap 112 also would facilitate the user to rotate the stand 100 relative the leg that is retained within the gap 112, thereby enabling the user to change the position of the stand 100.

In some other embodiment, the multi-purpose stand 100 may comprise one or more adjusting means (not shown). The adjusting means may be placed between the lower end 102b of the first surface and the upper end 104a of the second surface 104. The adjusting means may be used to adjust the height of the first surface 102 according to the eye level of the user.

Although particular embodiments of the invention have been described in detail for purposes of illustration, various modifications and enhancements may be made without departing from the spirit and scope of the invention.

What is claimed is:

1. A multi-purpose stand, comprising:
a first surface, having one or more supporting means, for placing a computing device, wherein the computing device is placed on the first surface using one or more supporting means;
a second surface having a front side and a back side, wherein the first surface is extended to form the second surface;
a third surface, wherein the third surface is connected to the back side of the second surface and for supporting for the second surface; and
wherein the front side of the second surface is used for writing and/or drawing by a user.

2. The multi-purpose stand as claimed in claim 1, wherein the first surface, second surface and the third surface include white board powder coating.

3. The multi-purpose stand as claimed in claim 1, wherein the supporting means comprises one or more protrusions on the first surface.

4. The multi-purpose stand as claimed in claim 1, wherein the supporting means are separated by a pre-defined distance.

5. The multi-purpose stand as claimed in claim 1, wherein the first surface further comprises:
one or more felt pads.

6. The multi-purpose stand as claimed in claim 5, wherein the one or more felt pads have different shapes.

7. The multi-purpose stand as claimed in claim 5, wherein the one or more felt pads acts as a cushioning means for the computing device.

8. The multi-purpose stand as claimed in claim 1, wherein the computing device is a laptop.

9. The multi-purpose stand as claimed in claim 1, wherein the third surface further comprising:
one or more apertures adapted for receiving one or more cushioning means;
wherein the one or more cushioning means are configured to provide cushioning to the multi-purpose stand with respect to a surface on which the multi-purpose stand is placed.

10. The multi-purpose stand as claimed in claim 1, wherein the first surface, second surface and the third surface are made of metal.

11. The multi-purpose stand as claimed in claim 10, wherein the metal is steel or aluminum.

12. The multi-purpose stand as claimed in claim 1, wherein content can be written/drawn on the second surface using a white board marker.

13. The multi-purpose stand as claimed in claim 1, wherein the content written/drawn on the second surface is erasable.

14. The multi-purpose stand as claimed in claim 1, further comprises:
one or more adjusting means placed between the first surface and the second surface;
wherein the one or more adjusting means are configured to adjust the angle of inclination of the first surface.
